(19) United States
(12) Patent Application Publication
(10) Pub. No.: US 2016/0263753 A1
(43) Pub. Date: Sep. 15, 2016

(54) SCISSORS

(71) Applicant: HIKARI CORPORATION, Itabashi-ku (JP)

(72) Inventor: Kazuyoshi TAKAHASHI, Itabashi-ku (JP)

(73) Assignee: HIKARI CORPORATION, Itabashi-ku (JP)

(21) Appl. No.: 15/035,035

(22) PCT Filed: Nov. 8, 2013
(86) PCT No.: PCT/JP2013/080246

§ 371 Date: May 6, 2016

(51) Int. Cl. B26B 13/26; B26B 13/20; B26B 13/14

(52) U.S. Cl. CPC B26B 13/26; B26B 13/14; B26B 13/20

(57) ABSTRACT

Provided are scissors with which the use of a thumb or the bending of a wrist can be reduced, and which can be used even by a hairdresser already suffering from tenosynovitis. Two half bodies are pivotably connected by a shaft support part. The first half body has a grip part, and the second half body has a trigger part. The grip part is supported by being sandwiched between the thenar and the bases of the four fingers, as well as being in contact with the palm line formed between the thenar and the bases of the four fingers. The tips of the third and fourth fingers are hooked onto the trigger part. When the third and fourth fingers are flexed, the second half body pivots in the closing direction via an extension part, and blade parts overlap one another, thereby cutting hair.

### TECHNICAL FIELD

The present invention relates to scissors. More specifically, the present invention relates to scissors for hair dressing or beauty.

### BACKGROUND ART

One of occupational diseases which hairdressers and beauticians suffer from is tenosynovitis of a finger or a wrist. After hairdressers and beauticians have attended to hair cutting over many years, they often suffer from tenosynovitis, specifically, of a thumb (pollex) due to repetition of opening/closing operation of scissors. Further, during hair cutting, hairdressers (hereinafter, including beauticians) are forced to keep an uncomfortable position, e.g., to bend the wrist excessively. This may get the hairdressers to suffer from tenosynovitis of wrist.

In order to avoid tenosynovitis, proposed is, for example, the conventional art disclosed in Patent Literature 1. More specifically, proposed is the art to form a hollow portion at least partially in a grip handle of the scissors as well as to enclose viscoelastic body within the hollow portion. Excellent impact buffering power and vibration absorbing power of the viscoelastic body can reduce vibration received by a palm body, the vibration being caused by the opening/closing operation of the scissors. Therefore, burden to the thumb and the wrist can be remarkably reduced. This can prevent the hairdressers from suffering from tenosynovitis.

### CITATION LIST

### Patent Literature

[Patent Literature 1]

WO2006/022368

### SUMMARY OF INVENTION

### Technical Problem

However, the conventional art is directed to the scissors for preventing tenosynovitis. Thus, a hairdresser already suffering from tenosynovitis cannot expect a sufficient effect from the scissors of the conventional art. In other words, the use of the scissors according to the conventional art still requires operations of using the thumb in opening/closing of the scissors and forcing the uncomfortable position, e.g., excessive bending of the wrist, while hair cutting. It is hard for the thumb or the wrist already suffering from tenosynovitis to perform the above described operations.

Development of scissors is demanded by hairdressers already suffering from tenosynovitis. More specifically, demanded are scissors with which the use of the thumb can be reduced and the excessive bending of the wrist can be eliminated.

The present invention was made to solve the above described problems. More specifically, a purpose of the present invention is to provide the scissors capable of reducing the use of the thumb. Another purpose of the present invention is to provide the scissors capable of eliminating the necessity of the excessive bending of the wrist.

### Solution to Problem

The present invention was made to solve the above described problems. The scissors of the present invention includes a first scissors half body with a blade part and a second scissors half body with a blade part, the first scissors half body and the second scissors half body being pivotably connected by a shaft support part, wherein the first scissors half body has a grip part, wherein the second scissors half body has a trigger part, wherein the grip part is supported by being sandwiched between a thenar and bases of four fingers, as well as being in contact with a palm line formed between the thenar and the bases of the four fingers, and wherein a tip of at least one of the four fingers (second to fifth fingers) is hooked onto the trigger part.

The first scissors half body is fixed when the grip part is gripped in a palm. Meanwhile, when the finger which is hooked onto the trigger part is flexed, the second scissors half body pivots in a closing direction with respect to the first scissors half body. This enables cutting of an object. At the time, a thumb (pollex) serves to only support a side surface of the grip part, so that the use of the thumb can be reduced.

In the above described invention, preferably, the blade part of the first scissors half body is inclined at an angle of 45 to 75 degrees (60 plus/minus 15 degrees) toward a side of the four fingers with respect to the grip part while the grip part is supported.

Because a long axis of the blade part of the first scissors half body is inclined at the angle of about 60 degrees toward the side of the four fingers with respect to the grip axis, the long axis of the blade part of the first scissors half body is fixed in parallel with the ground while the grip part is gripped in the palm at a basic position. This enables suitable cutting of the object.

In the above described invention, preferably, a pivot plane formed between the first scissors half body and the second scissors half body is inclined at a predetermined angle toward a side of the pollex with respect to a virtual center plane of the grip part formed between the thenar and the bases of the four fingers.

Further preferably, the predetermined angle falls within a range between 20 and 40 degrees (30 plus/minus 10 degrees).

Because the pivot plane is inclined at the angle of about 30 degrees toward the side of the pollex (thumb) with respect to the virtual center plane of the grip part, the pivot plane is formed in parallel with an operator when the operator grips the grip part in his palm at the basic position. When the operator takes his position facing to an object to be cut, the pivot plane is formed in parallel with a cutting line of the object. Specifically, in a case where the object to be cut is hair, the parallel position can be kept according to a curve of a head. This enables hair cutting in a suitable manner.

In the above described invention, preferably, the scissors further include a pushing member that pushes the second scissors half body in an opening direction with respect to the first scissors half body.

By means of the pushing member, the operator can repeat the opening/closing operation by only pivoting operation in the closing direction.

In the above described invention, preferably, the trigger part extends from a main body part of the second scissors half body in a rigidly connected manner.

By means of the trigger part, the pivoting operation in the closing direction becomes possible when the finger which is hooked onto the trigger part is flexed.

In the above described invention, preferably, the trigger part is a bar shaped member in which one end pivotably extends from the main body part of the second scissors half body and the other end pivotably extends from the grip part.

By means of the bar shaped trigger part, the angle of the trigger part can be finely adjusted. As a result thereof, the flexional operation of the finger can be more smoothly converted into the pivoting operation.

In the above described invention, preferably, the trigger part is a ring shaped member which pivotably extends from the main body part of the second scissors half body.

By means of the ring shaped trigger member, in addition to the pivoting operation in the closing direction according to the flexion of the finger, pivoting operation in the opening direction can be also realized according to spreading of the finger. This makes the pushing member useless.

In the above described invention, preferably, the grip part has a hit point at a contact portion between the grip part and the trigger part.

By means of the hit point, excessive pivoting is avoidable. Further, the hit point can buffer impact of hitting between the grip part and the trigger part and reduce hitting noise caused thereby.

In the above described invention, preferably, the grip part has a locking hook which can be hooked onto a web part of the back of hand.

By means of the locking hook, grip wobbling in a front-back direction can be reduced and secure support of the grip part is ensured.

In the above described invention, preferably, the grip part has guide grooves which guide the pollex and the second finger.

By means of the guide grooves, grip wobbling in a right or left direction can be reduced and secure support of the grip part is ensured.

### Advantageous Effect of Invention

According to the scissors of the present invention, the use of the thumb can be reduced. Further, the bending of the wrist can be reduced. As a result thereof, the operator already suffering from tenosynovitis can also use the scissors of the present invention.

### BRIEF DESCRIPTION OF DRAWINGS

FIG. 1 is a side view. <First Embodiment>

FIG. 2 is a side view. (the other side)

FIG. 3 is a side view. (closed position)

FIG. 4 is a rear perspective view.

FIG. 5 is a side view. (with auxiliary lines)

FIG. 6 is a plan view. (with auxiliary lines)

FIG. 7 illustrates a using position.

FIG. 8 illustrates a position of a dominant hand.

FIG. 9 illustrates a basic position. (front view)

FIG. 10 illustrates a basic position. (plan view)

FIG. 11 illustrates a basic position. (side view)

FIG. 12 illustrates a position other than the basic position.

FIG. 13 is a configuration diagram illustrating the scissors of the conventional art.

FIG. 14 illustrates the use of the scissors of the conventional art.

FIG. 15 is a side view. <Second Embodiment>

FIG. 16 is a side view. <Third Embodiment>

FIG. 17 is a side view. (First Modification Example)

FIG. 18 is a side view. (the other side)

FIG. 19 is a side view. (closed position)

FIG. 20A is a cross sectional view of a click mechanism for positioning.

FIG. 20B is a plan view of the click mechanism for positioning.

FIG. 21A is a cross sectional view of a slide pin mechanism for positioning.

FIG. 21B is a plan view of the slide pin mechanism for positioning.

FIG. 22 is an example of a universal design.

FIG. 23 is a side view. (Third Modification Example)

FIG. 24 is a side view. (Fourth Modification Example)

FIG. 25 is a plan view. (Fourth Modification Example)

FIG. 26 is a side view. <Fourth Embodiment>

### EMBODIMENTS FOR CARRYING OUT THE INVENTION

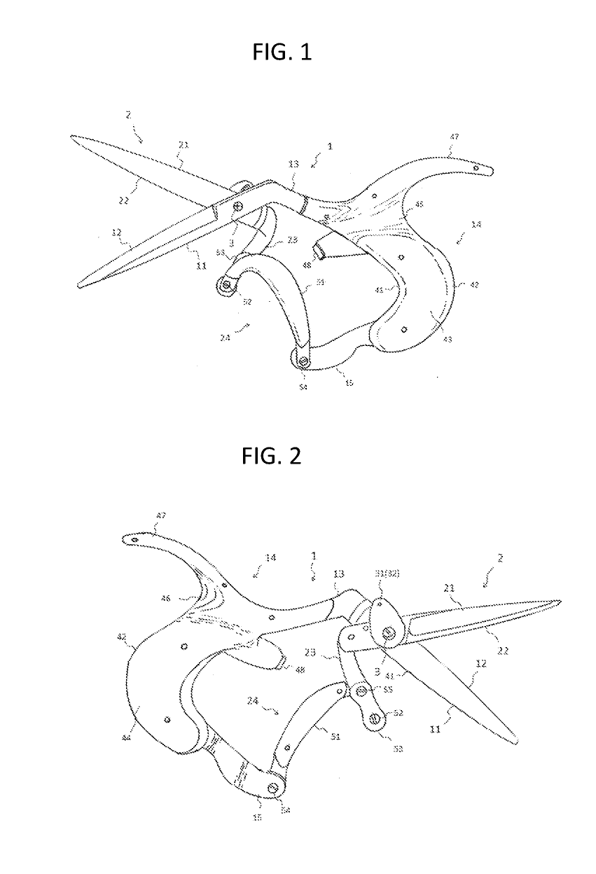

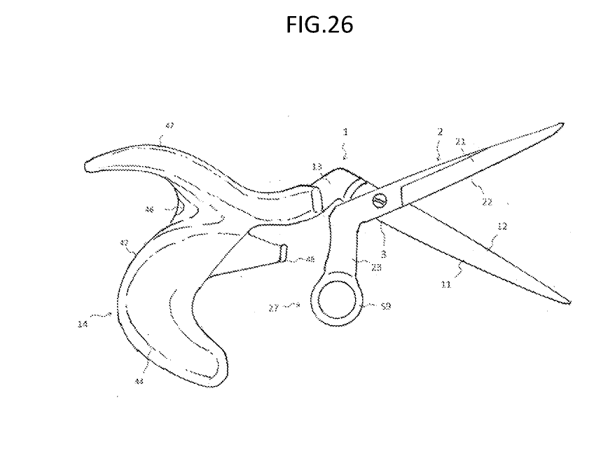

Embodiments of the invention according to the present application will be described below with reference to the attached drawings. FIGS. 1 to 11 relate to a first embodiment. FIG. 15 relates to a second embodiment. FIGS. 16 to 25 relate to a third embodiment. FIG. 26 relates to a fourth embodiment.

### First Embodiment

### Structure

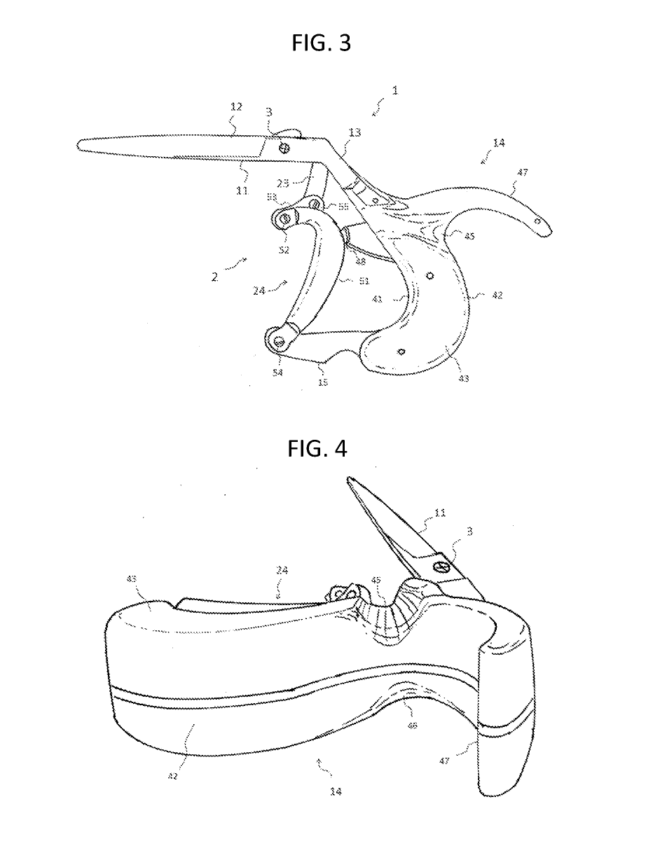

FIG. 1 is a side view of one side of scissors according to a first embodiment. FIG. 2 is a side view of the other side of the scissors according to the first embodiment. FIG. 1 and FIG. 2 illustrate an opening position. FIG. 3 is a side view illustrating a closed position. FIG. 4 is a perspective view viewed from the rear.

The scissors of the present embodiment includes a scissors half body 1 and a scissors half body 2 which are pivotably connected each other by a shaft support part 3 (screw or pivot pin).

The scissors half body 1 has a blade part 12 provided on a main body part 11 of the scissors half body 1 and further a grip part 14 which extends from the main body part 11 via an extension part 13 in a rigidly connected manner.

The extension part 13 extends integrally continuously from the main body part 11 and is inclined at an angle of about 60 degrees toward the opposite side of the blade part 12 with respect to a long axis of the main body part 11.

The grip part 14 may be formed into any shape in so far as the grip part 14 is securely supported by being wrapped within a palm of a dominant hand. For example, the grip part 14 may have a shape and a function similar to those of a grip of a pistol. More specifically, the grip part 14 has a front face part 41, a rear face part 42, and side face parts 43, 44. The rear face part 42 and the side face parts 43, 44 are in contact with an interior surface of the palm.

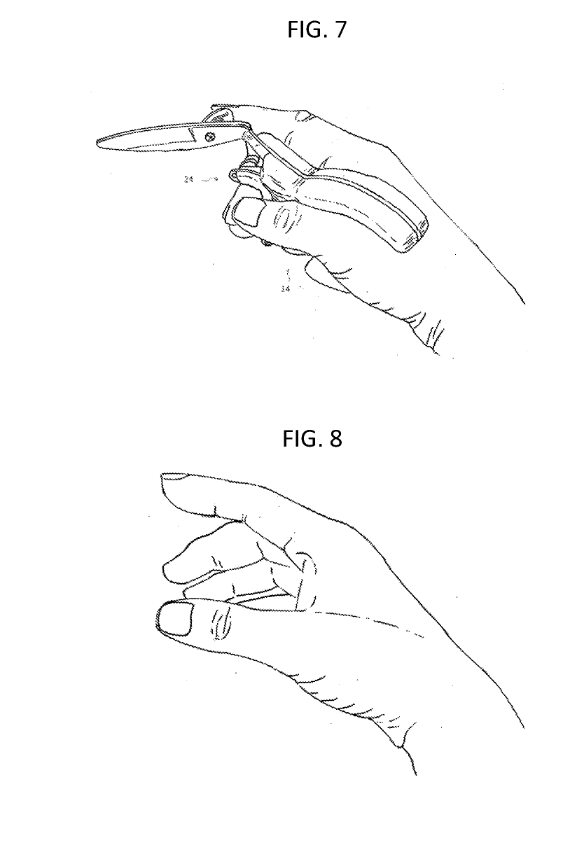

The rear face part 42 is in contact with a palm line formed between a thenar and bases of four fingers (four fingers other than a pollex). The side face part 43 is in contact with the thenar. The side face part 44 is in contact with the bases of the four fingers. The grip part 14 is thereby sandwiched between the thenar and the bases of the four fingers (see, FIG. 7 described below).

The side face parts 43, 44 are provided with guide grooves 45, 46, respectively. An upper portion of the rear face part 42 is provided with a locking hook 47. The pollex (thumb) is guided by and engaged in the guide groove 45. The second finger (index finger) is guided by and engaged in the guide groove 46. The locking hook 47 has an arch part that is hooked onto a web part of the back of hand (see, FIG. 7 described below).

The guide grooves 45, 46 and the locking hook 47 serve to reduce grip wobbling, and thus are not always essential if the grip part 14 is securely supported without them.

The front face part 41 is provided with a hit point 48 at a contact portion between the front face part 41 and the trigger part 24. In a case of expecting the hit point 48 of an impact buffering effect and a hitting noise reducing effect, it is preferred for the hit point 48 to be coated by resin.

The scissors half body 2 has a blade part 22 provided on a main body part 21 of the scissors half body 2. A trigger part 24 extends from the main body part 21 via an extension part 23.

The extension part 23 extends integrally continuously from the main body part 21 and is inclined at an angle of about 90 degrees toward a side of the blade part 22 with respect to a long axis of the main body part 21.

The trigger part 24 is a bar shaped member 51 of which both ends are pivotable. One end of the bar shaped member 51 is connected to a connecting part 53 via a hinge 52. The other end of the bar shaped member 51 is connected to an extension part 15 via a hinge 54. The other end of the connecting part 53 is connected to an end of the extension part 23 via a hinge 55. The extension part 15 is rigidly connected to an end of the grip part 14. As a result, the bar shaped member 51 is configured to have a link mechanism, in which one end pivotably extends from the main body part 21 and the other end pivotably extends from the grip part 14. The bar shaped member 51 has a gently curved arch shape. Tips of the third finger (middle finger) and the fourth finger (ring finger) are hooked onto an inner periphery of the arch.

The trigger part 24 and the extension part 23 which extends from the trigger part 24 may be formed into any shape in so far as flexional operation of the fingers can be converted into pivoting operation of the main body part 21. For example, the trigger part 24 and the extension part 23 may have a shape and a function similar to those of a trigger of a pistol.

A spring reaction force plate 31 is provided to the shaft support part 3 on a side of the scissors half body 2. A torsion spring 32 is interposed between the spring reaction force plate 31 and the scissors half body 2 (see, FIG. 6) and presses the scissors half body 2 in the opening direction with respect to the scissors half body 1. The elastic force of the torsion spring 32 serves to keep an opening position when no force is applied to the trigger part 24. When force is applied to the trigger part 24, the scissors half body 2 pivots in the closing direction with respect to the scissors half body 1 against the elastic force of the torsion spring 32. Therefore, it is preferable that the elastic force of the torsion spring 32 is sufficiently smaller than the force applied to the trigger part 24.

When scissors are not used, the elastic force of the torsion spring 32 keeps the scissors to the open position. Therefore, the scissors should be stored in a special case so as to keep the scissors in the closed position.

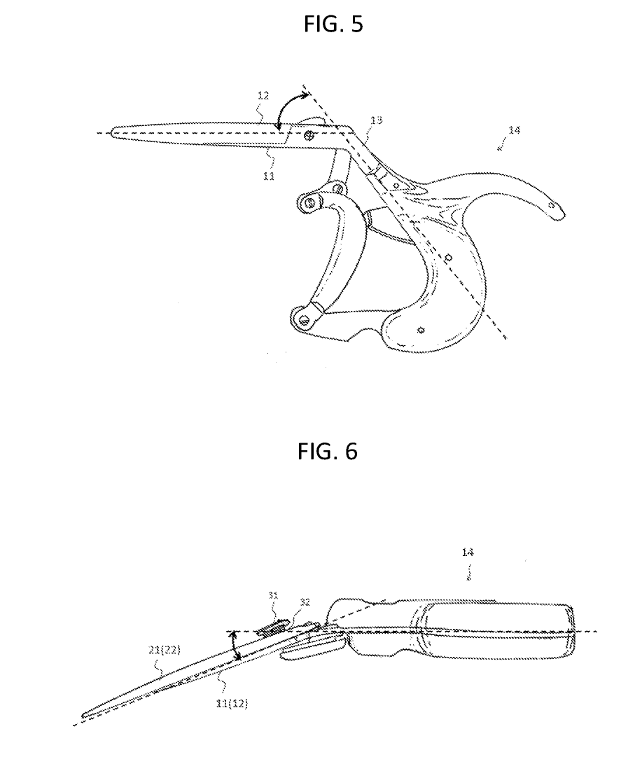

FIG. 5 is a side view with auxiliary lines added thereto. The long axis of the main body part 11 is in parallel with the long axis of the blade part 12. The long axis of the extension part 13 nearly coincide with a grip axis of the grip part 14. As a result thereof, the long axis of the blade part 12 is inclined at an angle of about 60 degrees toward the side of the four fingers with respect to the grip axis.

FIG. 6 is a plan view of the scissors with auxiliary lines added thereto. The virtual center plane of the grip part is formed between the side face parts 43, 44 (between the thenar and the bases of the four fingers). A track of the blade part 22 of the main body part 21 forms a pivot plane with respect to the blade part 12 of the main body part 11. The pivot plane of the blade parts 12, 22 is inclined at an angle of about 30 degrees toward a side of the pollex (thumb) with respect to the virtual center plane of the grip part. The virtual center plane of the grip part and a pivot plane of the trigger part 24 exist on the same plane. In other words, the pivot plane of the blade parts 12, 22 is inclined at the angle of about 30 degrees toward the pollex with respect to the pivot plane of the trigger part 24.

˜Operation˜

Operation of the scissors of the present embodiment will be described below. FIG. 7 illustrates a use position of the scissors of the present embodiment. FIG. 8 illustrates a position of the dominant hand in using the scissors.

Holding operation of the grip part 14 will be described below. The palm line formed between the thenar and the bases of the four fingers (second finger to fifth finger) is brought into contact with the rear face part 42 of the grip part 14. The pollex is engaged in the guide groove 45 as well as the second finger is engaged in the guide groove 46. The grip part 14 is sandwiched between the thenar and the bases of the four fingers. Further, the arch part of the locking hook 47 is locked on the web part of the back of hand. This enables secure support of the grip part 14 within the palm.

Opening/closing operation of scissors will be described below. While the grip part 14 is gripped within the palm, the scissors half body 1 is fixed in the palm. Meanwhile, when the third and fourth fingers which are hooked onto the trigger part 24 are flexed, the scissors half body 2 pivots in the closing direction via the extension part 23 with respect to the scissors half body 1, and thus the blade parts 12, 22 overlap one another, thereby cutting hair. At the time, the trigger part 24 contacts the hit point 48.

When the third and fourth fingers which are hooked onto the trigger part 24 are spread, elastic force of the torsion spring 32 is released, and the scissors half body 2 pivots in the opening direction with respect to the scissors half body 1 to cause the blade parts 12, 22 to be apart from each other. Repetition of flexion and spread of the third and fourth fingers enables a series of hair cutting.

In the series of cutting operation, the thumb (pollex) serves only to support a side surface of the grip part, and thus the thumb shall not be used excessively.

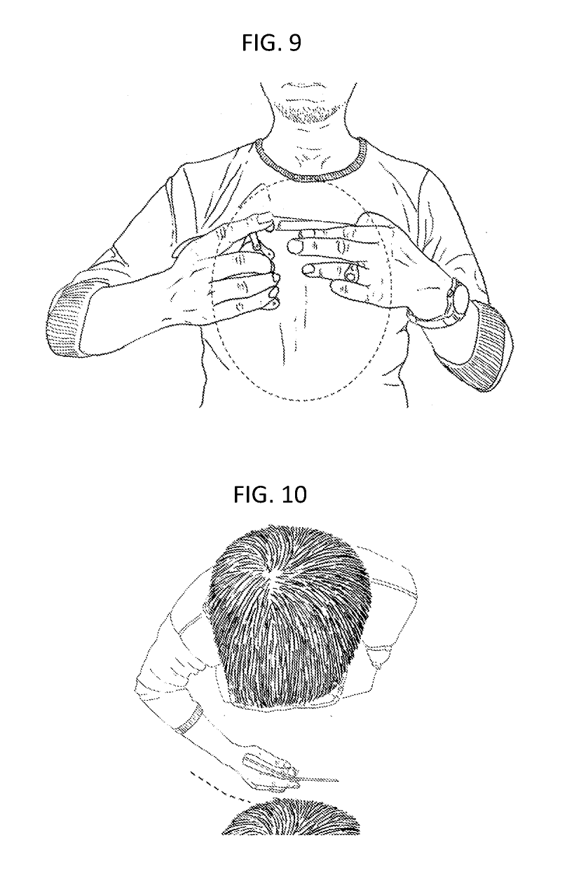

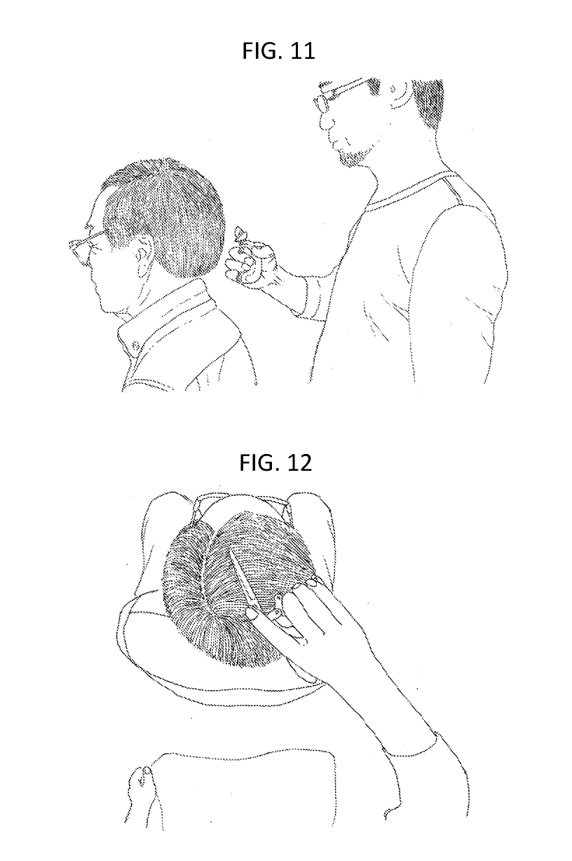

A basic position for hair cutting will be described below. FIGS. 9 to 11 illustrate basic positions. FIG. 9 is a front view. FIG. 10 is a plan view. FIG. 11 is a side view.

A hairdresser moves to a position facing to an object to be cut (a portion of hair to be cut). The hairdresser shall flex his elbow softly and draw a circle in front of his chest. Then, the hairdresser shall grip the scissors with his dominant hand and grab the hair with the other hand.

Because the long axis of the blade part 12 of the scissors half body 1 is inclined at the angle of about 60 degrees toward the side of the four fingers with respect to the grip axis (see, FIG. 5), the long axis of the blade part 12 of the scissors half body 1 is fixed in parallel to the ground while the hairdresser grips the grip part 14 in his palm at the basic position. As a result, movement of the scissors in parallel to the ground enables suitable hair cutting.

Because the pivot plane is inclined at the angle of about 30 degrees toward the side of the pollex (thumb) with respect to the virtual center plane of the grip part (see, FIG. 6), the pivot plane is formed in parallel to the hairdresser (front) while the hairdresser grips the grip part 14 in his palm at the basic position. Because the hairdresser takes the position facing to the object to be cut, the pivot plane is formed so as to be in parallel to a cutting line of the object. As a result, the hairdresser can keep the parallel position according to the curve of the head. This enables hair cutting in a suitable manner.

A beautician moves to the position facing to the object to be cut while keeping the basic position so as to make adjustment of his position in the plane direction. Further, the beautician moves his arm in a height direction to make fine adjustment in the height direction.

Even with the fine adjustment of the basic position, it is impossible to cut the hair around the head top. Therefore, the beautician shall take another position to cover the head top with his palm. FIG. 12 illustrates the position for cutting hair around a head top.

Because the pivot plane is inclined at the angle about 30 degrees toward the side of the pollex (thumb) with respect to the virtual center plane of the grip part (see, FIG. 6), the pivot plane is formed so as to be in parallel with the cutting line around the head top while the beautician grips the grip part 14 in his palm at the position. As a result, the beautician can keep the parallel position according to the curve of the head. This enables hair cutting in a suitable manner.

˜Effect˜

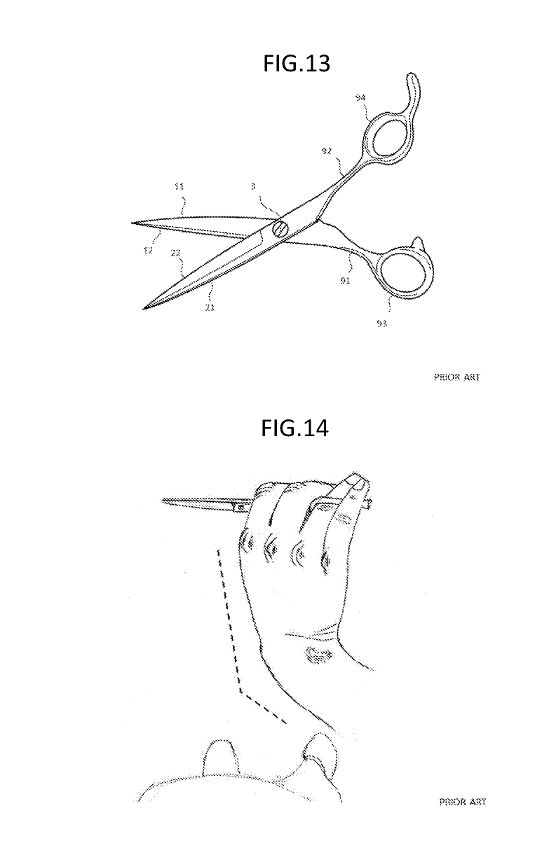

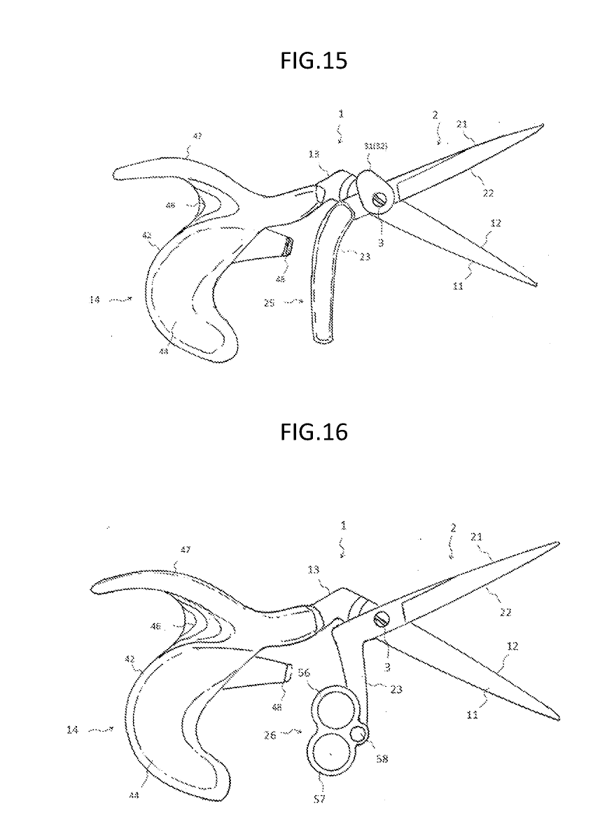

A main effect of the scissors of the present invention will be described below in comparison with the scissors of the conventional art. FIG. 13 is a configuration diagram illustrating scissors of the conventional art. FIG. 14 illustrates how to use the scissors of the conventional art.

The scissors of the conventional art is configured such that the scissors half body 1 and the scissors half body 2 are pivotably connected by a shaft support part 3. The scissors half body 1 has the blade part 12 which is provided on a main body part 11 of the scissors half body 1 and further has a ring part 93 which extends via a grip handle 91. The scissors half body 2 has the blade part 22 which is provided on the main body part 21 of the scissors half body 2 and further has a ring part 94 which extends via a grip handle 92.

The tip of the pollex (thumb) is hooked onto the ring part 93, and the tip of the fourth finger (ring finger) is hooked onto the ring part 94. The second and third fingers softly support the grip handle 92 to assist support of the scissors half body 2. When the ring part 93 and the ring part 94 are made closer to each other, the main body parts 11, 21 pivot at the shaft support part 3 as a fulcrum (supporting point) to cause the blade parts 12, 22 to overlap one another, thereby cutting hair.

At the time, because the thumb is caused to work repeatedly, the hairdresser already suffering from tenosynovitis cannot use the scissors of the conventional art.

A pivot plane of the ring parts 93, 94 and a pivot plane of the blade parts 12, 22 exist on the same plane. As a result thereof, when the hairdresser attempts to take the basic position, he is forced to take the uncomfortable position, e.g., to excessively bend his wrist. Therefore, the hairdresser already suffering from tenosynovitis of wrist cannot use the scissors of the conventional art.

To the contrary, in the present embodiment, the thumb (pollex) serves only to support the side surface of the grip part as described in the operation, so that the use of the thumb can be reduced. Consequently, the hairdresser already suffering from tenosynovitis of thumb also can use scissors.

Further, in the present embodiment, when the hairdresser takes the basic position, it is not required to bend his wrist in the uncomfortable way. This can reduce bending of the wrist. Therefore, the hairdresser already suffering from tenosynovitis of wrist also can use scissors.

An effect produced by another structure of the scissors of the present embodiment will be described below.

The hairdresser can repeat opening/closing operation by only pivoting operation in the closing direction owing to the force of the torsion spring 32.

The hit point 48 can prevent the excessive pivoting. Further, coating of resin to the hit point 48 serves to buffer impact of hitting between the grip part 14 and the trigger part 24 as well as reduce hitting noise thereof.

The locking hook 47 reduces the grip wobbling in the front-back direction to provide secure support of the grip part 14.

The guide grooves 45, 46 reduces the grip wobbling in the right or left direction to provide secure support of the grip part 14.

### Second Embodiment

In the first embodiment, the trigger part 24 was configured to have the link mechanism. However, a trigger part 25 in which the extension part 23 extends furthermore and the extension part 23 and its periphery are coated by, for example, resin may also be employed.

FIG. 15 is a side view of scissors according to a second embodiment. Like reference numerals as those of the first embodiment are attached to like or corresponding components. Some detailed reference numerals are omitted here. The trigger part 25 has a gently curved arch shape. The tips of the third finger (middle finger) and the fourth finger (ring finger) are hooked onto an inner periphery of the arch.

Other than the above, the second embodiment has the same structure as the first embodiment, and thus can produce a similar effect.

In comparison with the trigger part 24 of the first embodiment, the trigger part 25 is composed of less number of parts, i.e., has a simpler structure. This can save manufacturing cost and ensure little trouble.

### Third Embodiment

In the first embodiment, the trigger part 24 was configured to have the link mechanism. However, a trigger part 26 which is composed of rings and a hinge may also be employed.

FIG. 16 is a side view of scissors according to the third embodiment. Like reference numerals as those of the first embodiment are attached to like or corresponding components. Some detailed reference numerals are omitted here. The extension part 23 extends furthermore and has a gently curved arch shape. An inner periphery of the arch faces to a side of the grip part 14.

The trigger part 26 is composed of two rings 56, 57 which are connected to each other and pivotably extends from an end of the extension part 23 by the hinge 58. In other words, the trigger part 26 pivotably extends from the main body part 21 via the extension part 23 and the hinge 58. The tip of the third finger (middle finger) is hooked onto the ring 56. The tip of the fourth finger (ring finger) is hooked onto the ring 57.

Flexion of the third and fourth fingers which are hooked onto the trigger part 26 causes the scissors half body 2 to pivot in the closing direction with respect to the scissors half body 1 via the extension part 23. This causes the blade parts 12, 22 to overlap one another, thereby cutting hair. To the contrary, when the third and fourth fingers which are hooked onto the trigger part 26 are spread, the scissors half body 2 is caused to pivot in the opening direction with respect to the scissors half body 1 via the hinge 58 and the extension part 23. This causes the blade parts 12, 22 to be apart from each other. Repetition of flexion and spread of the third and fourth fingers enables a series of hair cutting.

Other than the above, the third embodiment has the same structure as the first embodiment, and thus can produce a similar effect.

In comparison with the trigger part 24 of the first embodiment, the trigger part 26 is composed of less number of parts, i.e., has a simpler structure. This can save manufacturing cost and ensure little trouble.

Because the trigger part 26 is composed of the rings 56, 57, spreading of fingers also enables pivoting in the opening direction. As a result thereof, the spring reaction force plate 31 and the torsion spring 32 become useless, and thus number of parts can be reduced more.

### First Modification Example

A modification example of the third embodiment will be described below. The modification example additionally includes a pivoting hinge 61 added to the scissors half body 1 of the third embodiment. Incidentally, the pivoting hinge 61 may be added to the scissors half body 1 of the first and second embodiments.

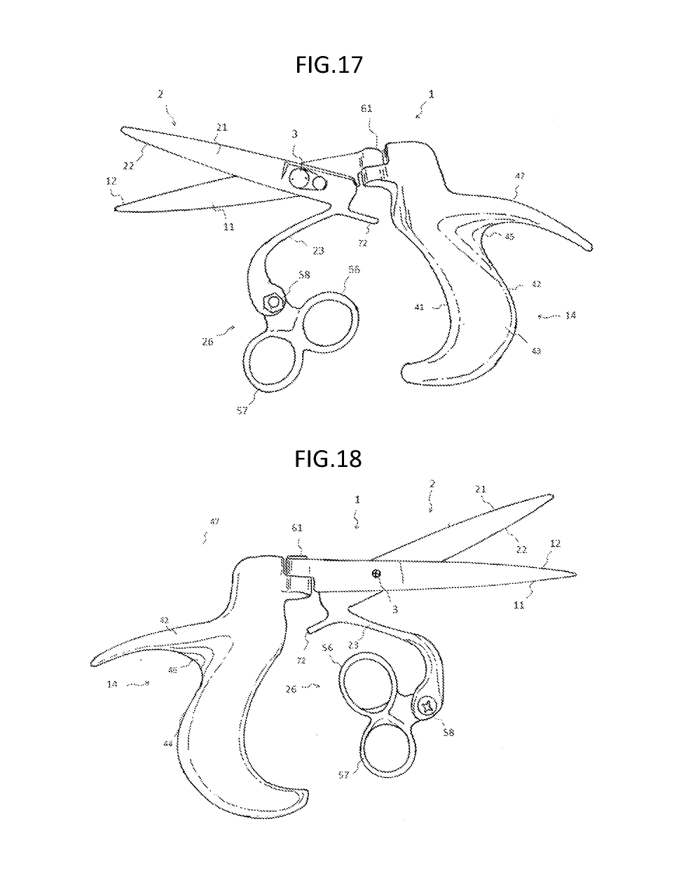

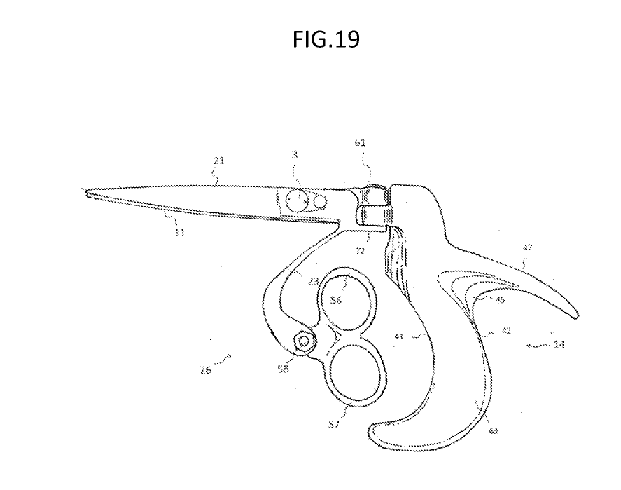

FIG. 17 is a side view of one side and FIG. 18 is a side view of the other side of the scissors according to the first modification example. FIG. 17 and FIG. 18 illustrate the opening position. FIG. 19 is a side view illustrating the closed position. Like reference numerals as those of the third embodiment are attached to like or corresponding components. Some detailed reference numerals are omitted here.

In the first to third embodiments, the grip part 14 extends from the main body part 11 via the extension part 13 in a rigidly connected manner. However, in the first modification example, the grip part 14 is pivotably connected to the main body part 11 via the pivoting hinge 61.

Click mechanism for positioning or slide pin mechanism for positioning may be utilized for the pivoting hinge 61.

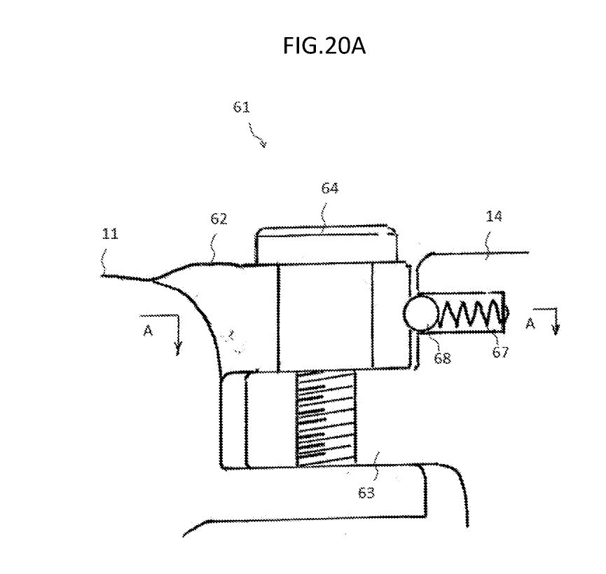

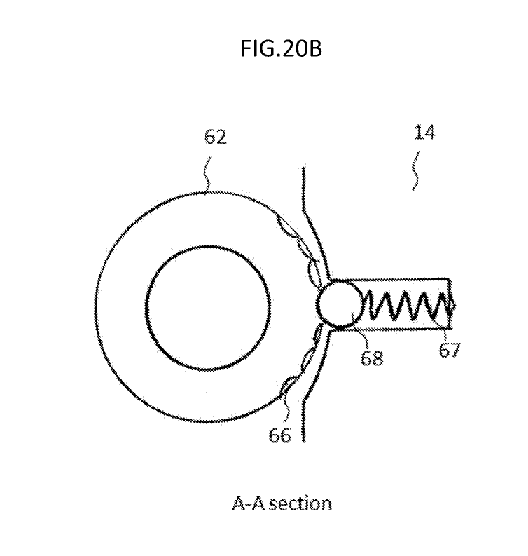

FIG. 20 is a detailed view of the click mechanism for positioning. FIG. 20A is a cross sectional view illustrating a side surface. FIG. 20B is a cross sectional view illustrating a plane surface. The pivoting hinge 61 serves to fix a scissors main body side-pivoting hinge 62 and a grip side-pivoting hinge 63 by using a screw 64. The scissors main body side-pivoting hinge 62 has an approximately cylinder shape and is provided with a plurality of positioning grooves 66 on its side surface. The grip side-pivoting hinge 63 includes a hollow portion into which a spring 67 is inserted. A ball 68 is serially positioned at an end of the spring 67. Elastic force of the spring 67 brings the ball 68 into contact with either one of the positioning grooves 66.

In a case of changing a pivoting position of the pivoting hinge 61, the screw 64 is loosen so as to allow the main body part 11 to pivot with respect to the grip part 14. Then, the ball 68 slides over the side surface of the positioning groove 66 to be in contact with the neighboring positioning groove 66. Then, the screw 64 is screwed again to be tightened securely.

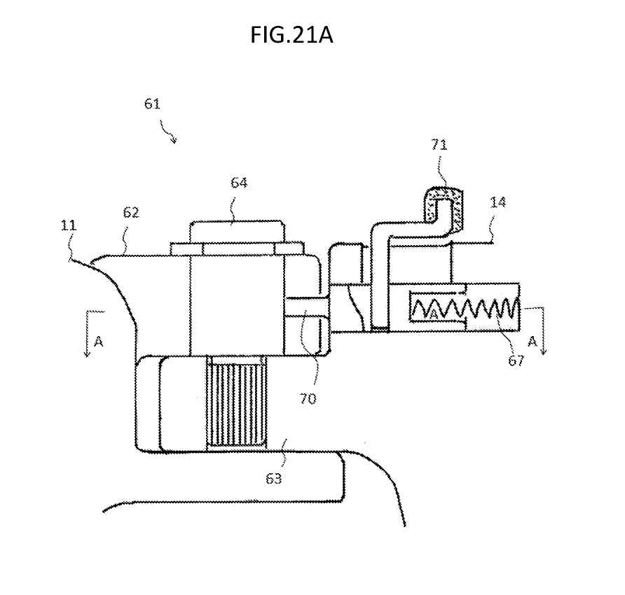

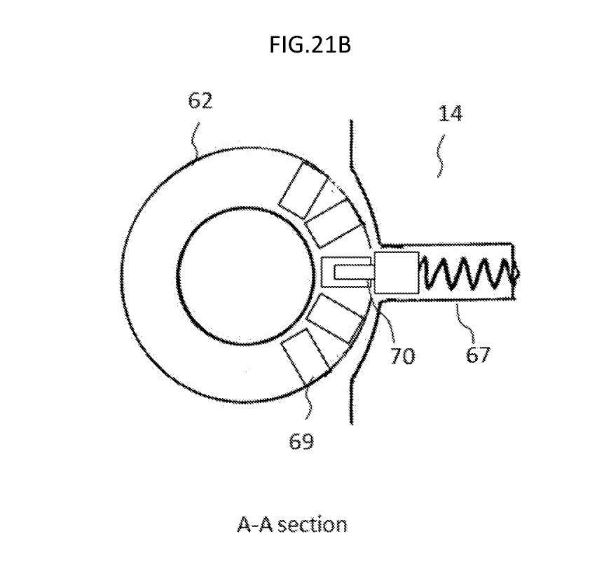

FIG. 21 is a detail view of the slide pin mechanism for positioning. FIG. 21A is a cross sectional view. FIG. 21B is a plan view. The pivoting hinge 61 serves to fix the scissors main body side-pivoting hinge 62 and the grip side-pivoting hinge 63 by using the screw 64. The scissors main body side-pivoting hinge 62 has an approximately cylinder shape and is provided with a plurality of positioning holes 69 in its side surface. The grip side-pivoting hinge 63 includes a hollow portion into which the spring 67 is inserted. A positioning pin 70 is serially positioned at an end of the spring 67. Elastic force of the spring 67 causes the positioning pin 70 to be fit into any one of the positioning holes 69. The positioning pin 70 has an engagement release lever 71. The engagement release lever 71 is coated with resin for the purpose of protection of the fingers.

In a case of changing a pivoting position of the pivoting hinge 61, the screw 64 is initially loosen. When the engagement release lever 71 is pulled, the positioning pin 70 is pulled out from the positioning hole 69. While keeping the pulled-out state of the positioning pin 70, if the main body part 11 pivots with respect to the grip part 14 and if the engagement release lever 71 is released, the positioning pin 70 is fit into another positioning hole 69. Then, the screw 64 is screwed again to be tightened securely.

The pivoting hinge 61 enables adjustment of the angle of the pivot plane formed by the blade parts 12, 22 with respect to the virtual center plane of the grip part within a range between −30 and 30 degrees.

Further, a hit point 72 may be provided on a side of the scissors half body 2. According to opening/closing operation of the scissors, the hit point 72 contacts a periphery of the grip side-pivoting hinge 63 of the grip part 14.

FIGS. 1 to 16 illustrating the first to third embodiments are made provided that the right hand is the dominant hand. In a case where the left hand is the dominant hand, additional drawings which illustrate scissors having a symmetrical structure are to be prepared. Generally, a rate of left-handed hairdressers is small, and thus cost for manufacturing the scissors for left-handed hairdressers becomes expensive.

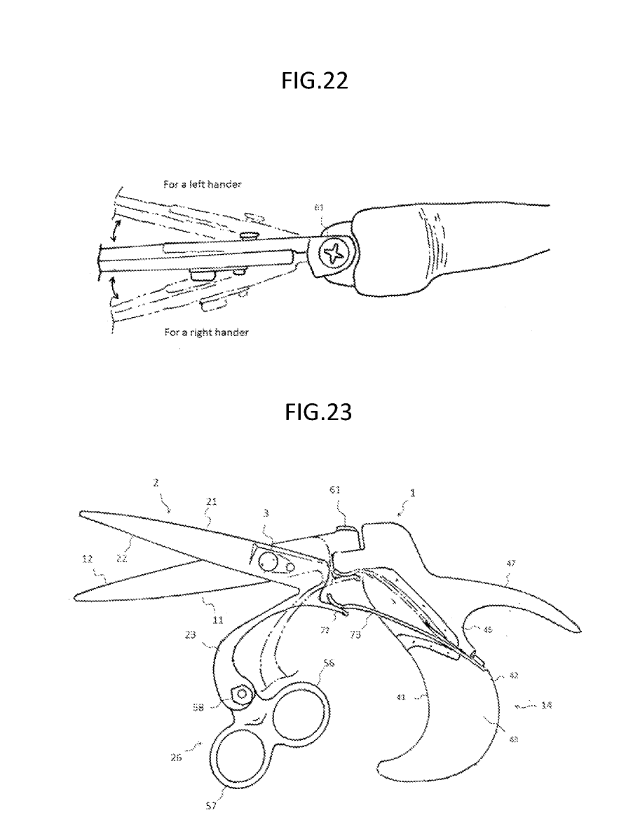

FIG. 22 illustrates an example of universal design. The scissors can be adjusted for both of the right-handed hairdressers and the left-handed hairdressers by changing the pivoting position of the pivoting hinge 61. With the structure, scissors can be provided to the left-handed hairdressers at low price.

### Second Modification Example

The trigger part 26 may be configured to take a folded angle according to the virtual center plane of the grip part. A smoother pivoting operation can be expected by the above configuration.

However, in order to adjust the scissors for the left-handed hairdressers, the trigger part 26 is to be provided in a vertically symmetric manner with respect to the hinge 58. Therefore, the folded angle of the trigger part 26 also becomes laterally symmetric.

### Third Modification Example

In the third embodiment, the trigger part 26 composed of the rings 56, 57 makes the pushing members such as the reaction force plate 31 and the torsion spring 32 useless. However, the pushing members may be employed in a third modification example.

FIG. 23 is a side view of one side of the scissors according to the third modification example. The grip part 14 includes a hollow portion into which a leaf spring 73 is inserted. One end of the leaf spring 73 is fixed to the grip part 14, and the other end of the leaf spring 73 is fixed to the hit point 72.

In a case where elastic force of the leaf spring 73 is not applied to the trigger part 26, the scissors half body 2 is pushed in the opening direction with respect to the scissors half body 1. When the trigger part 26 receives the force, the scissors half body 2 pivots in the closing direction with respect to the scissors half body 1 against the elastic force of the leaf spring 73.

### Fourth Modification Example

The scissors according to the first to third embodiments are intended to be used by hairdressers. However, the scissors can be used by also a person working in cloth-making such as dress-making and kimono-making.

However, the basic position for cutting hair by the hairdresser differs from the basic position for cutting cloth by the person working in cloth-making. In many cases, the person working in cloth-making cuts cloth at his front from his side to another side, i.e., at right angle from his front. Therefore, a structure in which the pivot plane is inclined at the angle of about 30 degrees toward the side of the pollex with respect to the virtual center plane of the grip part (see, FIG. 6) is useless.

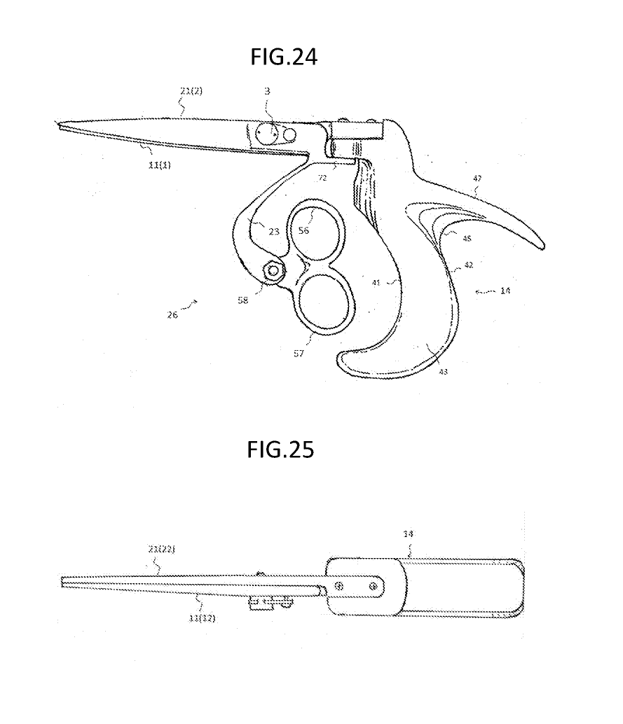

FIG. 24 is a side view of one side of the scissors according to a fourth modification example. FIG. 25 is a plan view of the scissors according to the fourth modification example. The virtual center plane of the grip part and the pivot plane exist almost in the same plane. When the grip part 14 is gripped in the palm and the fingers which are hooked onto the trigger part 26 are flexed, the main body part 21 pivots in the closing direction with respect to the main body part 11 to cause the blade parts 12, 22 overlap one another, thereby cutting cloth. At the time, the thumb (pollex) serves to only support the side surface of the grip part. Therefore, the use of the thumb can be reduced. Therefore, the person working in cloth-making and already suffering from tenosynovitis of thumb also can use scissors.

### Fourth Embodiment

A forth embodiment is a combination of the featured structure of the second embodiment and the featured structure of the third embodiment. FIG. 26 is a side view of the scissors according to the fourth embodiment. The extension part 23 extends furthermore and has a gently curved arch shape. An inner periphery of the arch faces to the side of the grip part 14.

The trigger part 27 is a ring 59 and extends from the end of the extension part 23 in a rigidly connected manner. The tip of the third finger (middle finger) or the fourth finger (ring finger) is hooked onto the ring 59. The trigger part 27 may be pivotable as similar to the hinge 58 of the third embodiment.

In the fourth embodiment, the trigger part 27 has a structure as simple as the structure of the trigger part 25 of the second embodiment and is formed into the ring 59 as similar to the third embodiment. This eliminates necessity of the pushing member. This can achieve a simple structure with less number of parts, save manufacturing cost, and ensure little trouble.

### REFERENCE CHARACTER LIST

1 scissors half body
2 scissors half body
3 shaft support part
11 main body part
12 blade part
13 extension part
14 grip part
15 extension part
21 main body part
22 blade part
23 extension part
24 trigger part (First Embodiment)
25 trigger part (Second Embodiment)
26 trigger part (Third Embodiment)
27 trigger part (Fourth Embodiment)
31 spring reaction force plate
32 torsion spring
41 front face part of grip part
42 rear face part of grip part
43, 44 side face part of grip part
45, 46 guide groove
47 locking hook
48 hit point
51 bar shaped member
52 hinge
53 connecting part
54 hinge
55 hinge
56, 57 ring
58 hinge
59 ring
61 pivoting hinge
62 scissors main body side pivoting hinge
63 grip side pivoting hinge
64 screw
66 positioning groove
67 spring
68 ball
69 positioning hole
70 positioning pin
71 engagement release lever
72 hit point
73 leaf spring
91, 92 grip handle (conventional art)
93, 94 ring part (conventional art)

1. Scissors for hair dressing beauty or cloth-making,
including a first scissors half body with a blade part and a second scissors half body with a blade part, wherein the first scissors half body and the second scissors half body are pivotably connected by a shaft support part:
wherein the first scissors half body has a grip part;
wherein the second scissors half body has a trigger part;
wherein the grip part is supported by being sandwiched between a thenar and bases of four fingers and by being wrapped within a palm, as well as being in contact with a palm line formed between the thenar and the bases of the four fingers;
wherein a tip of at least one of the four fingers is hooked onto the trigger part; and
wherein the blade part of the first scissors half body is inclined at an angle of 45 to 75 degrees toward a side of the four fingers with respect to the grip part while the grip part is supported.

2. (canceled)

3. The scissors according to claim 1, wherein a pivot plane between the first scissors half body and the second scissors half body is inclined at a predetermined angle toward a side of a pollex with respect to a virtual center plane of the grip part, the virtual center plane being formed between the thenar and the bases of the four fingers.

4. The scissors according to claim 3, wherein the predetermined angle falls within a range between 20 and 40 degrees.

5. The scissors according to claim 1 further comprising:
a pushing member that pushes the second scissors half body in the opening direction with respect to the first scissors half body.

6. The scissors according to claim 1 wherein the trigger part extends from a main body part of the second scissors half body in a rigidly connected manner.

7. The scissors according to claim 1 wherein the trigger part is a bar shaped member in which one end pivotably extends from the main body part of the second scissors half body and the other end pivotably extends from the grip part.

8. The scissors according to claim 1 wherein the trigger part is a ring shaped member that pivotably extends from the main body part of the second scissors half body.

9. The scissors according to claim 1 wherein the grip part has a hit point at a contact portion between the grip part and the trigger part.

10. The scissors according to claim 1 wherein the grip part has a locking hook that can be hooked onto a web part of the back of hand.

11. The scissors according to claim 1 wherein the grip part has guide grooves for guiding the pollex and the second finger.
